(19) United States
(12) Patent Application Publication
(10) Pub. No.: US 2005/0135605 A1
(43) Pub. Date: Jun. 23, 2005

(54) CRYPTOGRAPHIC EXPONENTIATION METHODS

(76) Inventors: Vassil S. Dimitrov, Calgary, Alberta (CA); Graham A. Jullien, Calgary, Alberta (CA)

Correspondence Address: EDWARD YOO C/O BENNETT JONES, 1000 ATCO CENTRE, 10035 - 105 STREET, EDMONTON, ALBERTA, AB, T5J3T2, CA

(21) Appl. No.: 10/905,156

(22) Filed: Dec. 17, 2004

Related U.S. Application Data
(60) Provisional application No. 60/481,806, filed on Dec. 17, 2003.

(51) Int. Cl. H04K 1/00

(52) U.S. Cl. 380/28

(57) ABSTRACT

A method of modular exponentiation for use in cryptographic systems based on a GF(2ⁿ) or GF(p) arithmetic includes a representation of the exponent as a sum of products of Fermat numbers and powers of two.

### BACKGROUND OF THE INVENTION

This application claims the priority benefit of U.S. Provisional Patent Application No. 60/481,806 filed on Dec. 17, 2003, the contents of which are incorporated herein.

The present invention relates to public key cryptography and, in particular, a method for modular exponentiation for use in a public key cryptosystem.

There is an increasing need for systems that permit data encryption, authentication and verification, driven by the increasing use and sophistication of data transmission in various fields. Examples may be found in telecommunications, networking, cellular communication, wireless communications, “smart card” applications, and audio-visual and video communications.

Public key cryptography is well known. Data may be encrypted by utilizing a pair of keys, one of which is public and one of which is private, and which are mathematically related. Data encrypted with the public key may only be decrypted with the private key and conversely, data encrypted with the private key can only be decrypted with the public key.

Currently accepted public key cryptosystems are those based on integer factorization and discrete logarithms in finite groups. In particular, the RSA system, the Diffie-Hellman key exchange and the ElGamal protocol are well-known and have been implemented worldwide.

The RSA encryption scheme is based on the integer factorization problem where two primes p and q are multiplied to provide a modulus n. The public key e and private key d are related such that their product e□d equals 1(modφ) where φ=(p−1)(q−1). A message M is encrypted by exponentiating it with the private key e to the modulus n, [C=M*(mod n)] and decrypted by exponentiating with the public key mod n[M=C^{d}(mod n)]. This technique requires the transmission of the modulus n and the public key and the security of the system is based on the difficulty of factoring a large number that has no relatively small factors. Accordingly both p and q must be relatively large primes.

One disadvantage of this system is that p and q must be relatively large (at least 512 bits) to attain an adequate level of security. With the RSA protocol this results in a 1024 bit modulus and a 512 bit public key, which requires significant bandwidth and storage capabilities. For this reason researchers have looked for public key schemes which reduce the size of the public key. Moreover, recent advances in analytical techniques and associated algorithms have rendered the RSA encryption scheme potentially vulnerable and accordingly raised concerns about the security of such schemes. This implies that larger primes, and therefore a larger modulus, need to be employed in order to maintain an acceptable level of security. This in turn increases the bandwidth and storage requirements for the implementation of such a scheme.

Elliptic curve cryptosystems (ECC) are analogs of existing public-key cryptosystems in which modular arithmetic is replaced by operations defined over elliptic curves. Elliptic curve cryptosystems are described in U.S. Pat. No. 6,141,420, the contents of which are incorporated herein by reference. Just as in all public key cryptosystems, the security of elliptic curve cryptosystems relies on the underlying hard mathematical problems. The elliptic curve discrete logarithmic problem has emerged as a hard problem with significant potential. The problem may simply be described. Assuming that G is a finite group, and a and b are elements of G, then determine a value x (when it exists) such that a^{x}=b. The value for x is called a logarithm of b to the base of a, and is denoted by logₐ b.

The difficulty of determining this quantity depends on the representation of G. For example, if the abstract cyclic group of order m is represented in the form of the integers modulo m, then the solution to the discrete logarithm problem reduces to the extended Euclidean algorithm, which is relatively easy to solve. However, the problem is made much more difficult if m+1 is a prime, and the group is represented in the form of the multiplicative group of the finite field Fₘ₊₁. This is because the computations must be performed according to the special calculations required for operating in finite fields.

It is also known that by using computations in a finite field whose members lie on an elliptic curve, that is by defining a group structure G on the solutions of y²+xy=x³+ax²+b over a finite field, the problem is again made much more difficult because of the attributes of elliptic curves. Therefore, it is possible to attain an increased level of security for a given size of key or use a reduced key size to maintain a similar degree of security.

However, when implementing a cryptosystem with elliptic curves, one is required to compute kP=P+P+ . . . +P (P added k times) where k is a positive integer and PεE, where E is the set of points on the elliptic curve. This requires the computation of (x₃, y₃) to be computed k−1 times. Even if alternative techniques such as “double and add” are utilized, it is still necessary to compute the addition of two points several times, each of which requires multiplications, additions and inverses in the underlying finite field. For large values of k which are typically necessary in cryptographic applications, this has been considered impractical for data communication.

From a hardware viewpoint, the space (area) complexity of the algorithms is at least as important as the time complexity, especially in the case of severe memory restrictions. Most of the algorithms based on the sliding window approach tend to use too much storage, although this is not often a consideration in the literature promoting such techniques. In the case of smart cards this is definitely an important component of the cost function.

Therefore, there is a need in the art for a method of exponentiation which minimizes the number of regular multiplications and the space (area) complexity of the algorithm.

### SUMMARY OF THE INVENTION

The present invention provides a new method of modular exponentiation based on a representation of the exponent as a sum of products of Fermat numbers and powers of two. The method may be effectively used in cryptosystems based on a finite field, such as those based on GF(2ⁿ) arithmetic and also those based on GF(p) arithmetic.

### BRIEF DESCRIPTION OF THE DRAWINGS

An exemplary embodiment of the invention will now be described with reference to the following drawings.

FIG. 1 shows a schematic depiction of one algorithm of the present invention

### DETAILED DESCRIPTION OF PREFERRED EMBODIMENT

The present invention provides for a method of modular exponentiation based on representation of the exponent as a sum of products of a Fermat number and a power of two.

As used herein, a Fermat number is given by the binomial number of the form Fₙ=2″+1. When describing the present invention, all terms not defined herein have their common art-recognized meanings.

Several well known commercial cryptosystems make use of an exponentiation over GF(2ⁿ). Curves over GF(2ⁿ) are typically of the form y²+xy=x³+x²=b while curves of GF(p) are typically of the form y²=x³−3x=b. In these cases, squaring can be assumed to be an almost free operation, if one uses the so-called normal bases representation, because squaring reduces to cyclic bit-shifts. Therefore, it is advantageous to look for methods that reduce, as much as possible, the number of regular multiplications at the price of an almost unlimited increase in the number of squarings. This consideration has been emphasized in an algorithm for performing arithmetic over GF(2ⁿ). For example, Newbridge Microsystems Corp. has used this algorithm in a cryptochip operating over GF(2⁵⁹³).

In general terms, the invention comprises a method of exponentiation in a data encryption system based on GF(2ⁿ) or GF(p) arithmetic utilizing a double base number representation of the exponent:

$$t = {\sum }_{i = 0}^{m} {F}_{k}^{i} ( {\sum }_{j = 1}^{c ( i )} {2}^{bi ( j )} )$$

where: Fₖ=2^{k}=1;

m is the maximal Fₖ exponent used;

c(i) is the number of binary exponents that correspond to the i-th Fₖ exponent, 0≦l≦m;

bᵢ^{(j)} is the j-th binary exponent which corresponds to the i-th Fₖ exponent, 1≦j≦c(i).

Theoretical Basis

The methods of the present invention may be understood as a method of minimizing the number of modular multiplications. The problem in minimizing the number of modular multiplications for exponentiation is closely related to the so-called addition chains. It is known that an addition chain for a given integer, t, is a succession of positive integers: a₁=1,a₂, . . . ,a₁=t such that for every p>1aₚ+aₖ for some k and j, 1≦j≦k≦1.

Obtaining at least one of the shortest addition chains for a given integer is known to be a NP-complete problem. The lower bound for the shortest addition chain length has been established; no addition chain for t can be shorter than log₂ t+log₂H(t)−2.13, where H(t) is the Hamming weight of t.

However, this interpretation of the problem does not distinguish between multiplications and squarings. A distinction between multiplications and squarings is important with exponentiations over GF(2″). This issue must be addressed in elliptic curve cryptosystems over GF(2″). Some even-characteristic Galois fields of practical importance in cryptography are: GF(2¹⁵⁵), GF(2¹⁶³), GF(2¹⁷⁶) and GF(2⁵⁹³). Generally speaking, for the present invention, the larger the field, the greater the computational savings.

If the exponent is a power of two, then only squarings are needed to perform exponentiation. If the exponent is a number of the form 2ⁿ+1, then n squarings and one regular multiplication are required. This very simple observation leads to the following representation:

$$t = {\sum }_{i + 1}^{d} {2}^{{a}^{( 1 )}} {F}_{k}^{{b}^{( 1 )}} , {F}_{k} = {2}^{k} + 1 \qquad ( 1 )$$

This representation shall be referred to herein as a binary-Fermat representation. Therefore, integers of the form 2^{a}Fₖ^{b}, Fₖ=2^{k}+1 nonnegativer integers are referred to as binary-Fermat numbers. Of course, if k is 1, then Fₖ is 3 and b may be referred to as the ternary exponent.

The representation (1) may be viewed as a generalization of the double-base number system (DBNS) [14, 15, 16]. All the applications of DBNS in [14, 15, 16] have been dedicated to fixed-base cryptosystems. The application of DBNS is the present invention is dissimilar to the prior art. It is to improve the performance of fixed-exponent cryptosystems by making use of an appropriate choice of the exponent in the form (1).

In one embodiment, the invention involves the case of odd bases having a Hamming weight two. However, it is worth investigating other bases with very small Hamming weights.

In one embodiment, consider the representation of the exponent of the form (1). The number of regular multiplications corresponding to this particular representation is given by:

$$RM ( t ) = {\underbrace{max}}_{i = 1 , 2 , … , d} {b}^{( i )} + d - 1$$

In this formula (2), d is the number of binary-Fermat numbers such that their sum gets exactly t by formula (1).

Finding a representation that corresponds to the global minimum of RM(t) is a challenging problem and is very difficult to solve. Instead, representations which lead to exponentiations with very few regular multiplications may be arrived by following heuristic rules.

In one embodiment, one method to compute some good representations of the form (1) is the so-called greedy algorithm. Providing that the odd (Fermat number) base is fixed, the greedy algorithm may be structured as follows: Step 1: Find the largest binary-Fermat number, q, (that is, q=2^{a}Fₖ^{b},a,b—nonnegative integers) smaller than or equal to t; Step 2: t=t−q; Step 3: If t>0 go to Step 1.

In this form the algorithm does not provide good representations that correspond to very small values of RM(t); however, it is possible to modify the algorithm to dramatically decrease the number of regular multiplications.

The first step is to obtain a suitable approximation of t of the form 2^{a}Fₖ^{b},a,b—nonnegative integers. One way to do that is to find a good approximation of log t of the form:
log t≈a log 2+blog Fₖ (3)
Accordingly, the theory of linear forms of logarithms invente by A. Baker is relevant. The theory allows the asymptotic estimation of d, the number of binary-Fermat numbers in (1). Assume that the following three theorems are true:

1. Any natural number n can be represented by as a sum of:

$$0 ( \frac{log n}{log log n} )$$

numbers of the form 2^{a}3^{b}.

2. Let p₁, p₂, . . . , pₛ be a set of s fixed primes. Then there is an absolute effectively computable constant C>0 such that there is always a number of the form

$${\prod }_{i = 1}^{s} {p}_{i}^{{e}_{i}} , {e}_{i} \geq 0$$

in the interval

$$[ n - \frac{n}{{( log n )}^{c}} , n ]$$

where n is an arbitrary positive integer (Tijdeman's theorem).

3. As Tiedeman's theorem is valid for the case s=2, p₁=2, p₂=Fₖ, then any natural n can be represented as a sum of

$$0 ( \frac{log n}{log log n} )$$

binary-Fermat numbers.

The proof of Theorem 1 can be obtained by applying Tijdeman's theorem for the special case s=2, p₁=2, p₂=3 and considering the sequence of integers n=n₀>n₁>n₂> . . . >n₁>n₁₊₁ generated by the greedy algorithm.

One skilled in the art will see that the result from Theorems 1 and 3 are preferable. Both theorems demonstrate that, on average, the DBNS and the binary-Fermat number representations require asymptotically smaller number of ones in representing integers as opposed to the binary number system. Therefore, one skilled in the art can expect asymptotic improvements of the performance of algorithms whose complexity depends upon the number of nonzero terms in the input data.

From a practical point of view it is also important to have some information about the implicit constant associated with the complexity analysis. Applying current results from number theory, we arrive at a rather pessimistic picture; i.e., all we can say about the constant C, used in Tijdeman's theorem, is that it is smaller than 10⁹.

Tijdeman's theorem itself produces several counter-intuitive conclusions. First of all, it shows that no matter how many bases are used (as long as their number is fixed and larger than one), one would have the same asymptotic estimation for the number of summands necessary and sufficient to represent a given integer n, that is,

$$0 ( \frac{log n}{log log n} )$$

The proof of Theorem 1 can be extended to any given finite set of primes, but the inventors have shown that computer experiments with the greedy algorithm with different sets of primes show significantly different performance. This is due to a strange number theoretic phenomenon: in the case of primes p₁=17, p₂=89, integers of the form 17^{a}89^{b}, a,b—nonnegative integers are distributed in clusters. In such special cases, the worst case behavior of the greedy algorithm might be particularly bad. But the general theory of linear forms of logarithms does not distinguish different choices of primes; that is, a proof that can be applied to the case p₁=2, p₂=3 would work equally well in the case p₁=17, p₂=89, for example. For this reason one inevitably gets large constants in applying general theorems from the theory of linear forms of logarithms. A special theory devoted to particular set of primes (say p₁=2, p₂=3) should give us a much more precise picture, but the invention of such a theory appears beyond the reach of the modern transcendental number theory. Computational experiments performed lead to the following conjecture: let p₁, p₂, . . . , pₛ be set of s fixed primes. Then every positive integer, n, can be represented as a sum of

$$\frac{2}{s} \frac{log n}{log log n} + g ( n )$$

numbers of the form

$${\prod }_{i = 1}^{s} {p}_{i}^{{e}^{i}} , {e}_{i} \geq 0$$

where

$${lim}_{n \to ∞} \frac{g ( n ) log log n}{log n} = 0.$$

In the case of DBNS and binary-Fermat number representation the conjecture posed would allow us to determine that the constant associated with the computational complexity analysis of the greedy algorithm is 1.

Finding Suitable Exponents

Therefore, in the present invention, a preferred representation of the exponent, t, relies on some restrictions on the powers of the Fermat numbers used. As stated above, the use of the greedy algorithm does not always provide preferred representations. The reason is if at some cycle in the algorithm (especially in the first few) the corresponding value of the obtained powers of two is low, the power of the odd base would be necessarily high, thus the total value of RM(t) would be high. Very high powers of two may be used as they correspond to squarings that are considered free in the computational model of the present invention. Therefore, restrictions on the powers of the Fermat numbers are preferred in order to reduce the total value of RM(t). As a positive by-product, these restrictions lead to simplification and speed up of the greedy algorithm.

Formula (1) implies that a suitable representation of the exponent may be found based on two conflicting conditions. If high values of the powers of the odd base used are allowed, then d, the number of summands, is reduced, but the maximal power of the odd base will lead to high value of RM(t) (1). Conversely, if the maximal power of the odd exponent is restricted, then the value of d increases.

Therefore, in one embodiment, a compromise between these two conflicting conditions is suitable. A suitable exponent representation may be obtained from heuristic rules. One skilled in the art may appreciate that a precise compromise is exceedingly difficult and likely not possible. These heuristic rules may be developed with reference to following examples of computational experiments. These examples are intended to be illustrative but not limiting of the claimed invention.

### EXAMPLES

### Example 1

Bases 2 and 3

The easiest case that can serve as a good illustration of the methods of the present invention involves the first two prime numbers as bases—2 and 3. Therefore, this example relates to representations of the exponent of the form

$$t = {\sum }_{i , j} {d}_{1 , j} {2}^{i} {3}^{j} , {d}_{1 , j} ɛ \{ 0 , 1 \}$$

where j is kept very small while making sure that the number of terms in equation (4) is significantly lower than the Hamming weight of t.

TABLE 1
Index-representation of t as a sum of numbers of the form 2^{a} 3^{b} with no restrictions on the powers of three, that is
T = 2³¹⁵ 3¹⁷⁵ + 2⁵⁰¹ 3⁵² + 2⁴²⁶ 3⁹³ + . . . + 2⁸ 3² + 2³ 3³ + 2⁰ 3¹

| | | | | | | | | | | | |
|---|---|---|---|---|---|---|---|---|---|---|---|
| 315, 175 | 501, 52 | 426, 93 | 279, 188 | 102, 286 | 112, 274 | 63, 299 | 392, 86 | 451, 52 | 342, 105 | 437, 39 | 154, 211 |
| 237, 153 | 199, 170 | 372, 55 | 260, 120 | 380, 38 | 211, 139 | 164, 162 | 327, 53 | 18, 241 | 80, 197 | 76, 193 | 44, 205 |
| 74, 181 | 121, 146 | 264, 50 | 319, 9 | 58, 168 | 24, 184 | 283, 16 | 107, 120 | 162, 79 | 193, 53 | 117, 95 | 169, 55 |
| 73, 107 | 196, 25 | 44, 114 | 85, 83 | 40, 105 | 42, 98 | 18, 108 | 57, 79 | 44, 83 | 123, 29 | 11, 94 | 49, 63 |
| 33, 69 | 17, 75 | 129, 0 | 58, 39 | 61, 33 | 75, 20 | 76, 15 | 44, 31 | 6, 51 | 67, 8 | 11, 39 | 57, 5 |
| 6, 33 | 49, 2 | 11, 22 | 16, 15 | 9, 16 | 3, 16 | 11, 8 | 5, 8 | 8, 2 | 3, 3 | 0, 1 | |

The representation of the same number in the form (4) with maximal ternary exponent 17 is shown on Table 2. This particular choice of the maximal ternary exponent, that is, 17, will be explained in the next sections.

TABLE 2
Index-representation of t as a sum of numbers of the form 2^{a}3^{b} with largest ternary exponent 17, that is,
T = 2⁵⁶⁷ 3¹⁶ + 2⁵⁶⁸ 3¹¹ + 2⁵⁶³ 3¹⁰ + . . . + 2¹³ 3⁰ + 2⁷ 3¹ + 2⁰ 3¹

| | | | | | | | | | | | |
|---|---|---|---|---|---|---|---|---|---|---|---|
| 567, 16 | 568, 11 | 563, 10 | 549, 16 | 570, 0 | 536, 17 | 532, 16 | 534, 12 | 547, 0 | 528, 8 | 517, 12 | 514, 11 |
| 501, 16 | 508, 8 | 489, 17 | 505, 3 | 489, 9 | 473, 15 | 470, 14 | 465, 12 | 476, 1 | 469, 1 | 448, 9 | 434, 15 |
| 436, 11 | 438, 7 | 416, 17 | 425, 7 | 419, 7 | 397, 17 | 394, 13 | 386, 14 | 392, 6 | 370, 14 | 371, 8 | 368, 6 |
| 348, 15 | 353, 9 | 336, 15 | 329, 16 | 334, 10 | 336, 6 | 317, 14 | 318, 10 | 305, 15 | 313, 7 | 297, 14 | 310, 2 |
| 298, 5 | 278, 13 | 273, 11 | 249, 16 | 257, 7 | 248, 8 | 227, 13 | 216, 17 | 210, 16 | 226, 3 | 218, 2 | 203, 7 |
| 198, 7 | 181, 15 | 189, 6 | 180, 8 | 172, 10 | 172, 7 | 152, 16 | 148, 15 | 154, 7 | 142, 10 | 152, 1 | 131, 9 |
| 126, 9 | 113, 14 | 99, 13 | 104, 7 | 81, 17 | 86, 17 | 84, 9 | 86, 3 | 65, 12 | 68, 7 | 60, 9 | 44, 16 |
| 48, 10 | 39, 13 | 41, 7 | 32, 10 | 31, 6 | 34, 1 | 26, 2 | 14, 5 | 14, 2 | 13, 0 | 7, 1 | 0, 1 |

Where there are no restrictions on the ternary exponent, the number of regular multiplications, RM(t), is 369—determined as 299 (the largest ternary exponent participating in the DBNS representation) plus 71 (the number of summands of the form 2^{a}3^{b}) minus one. It is in sharp contrast to the second case, where the number of RM(t) is 112, where the largest allowed ternary exponent is 17.

### Example 2

—Algorithm for exponentiation with low number of regular multiplications.

This example demonstrates a preferred efficient use of the representation scheme disclosed herein.

In order to make the representation as suitable as possible for efficient exponentiation, the pairs (binary-exponent, ternary-exponent) may preferably be reordered in increasing order of the ternary exponent. For the number used in Table 2, Example 1, this particular reorder is shown on Table 3:

TABLE 3
The reordered representation of the exponents shown in Table 2

| | The corresponding exponents of two, in | Number of |
|---|---|---|
| Ternary | increasing order, participating in the | exponents of |
| exponent | representation of t | two |
| 0 | 13, 547, 570 | 3 |
| 1 | 0, 7, 34, 152, 469, 476 | 6 |
| 2 | 14, 26, 218, 310 | 4 |
| 3 | 86, 226, 505 | 3 |
| 4 | — | 0 |
| 5 | 14, 298 | 2 |
| 6 | 31, 189, 336, 368, 392 | 5 |
| 7 | 41, 68, 104, 154, 172, 198, 203, 257, 313, | 12 |
| | 419, 425, 438 | |
| 8 | 180, 248, 371, 508, 528 | 5 |
| 9 | 60, 84, 126, 131, 353, 448, 489 | 7 |
| 10 | 32, 48, 142, 172, 318, 334, 563 | 7 |
| 11 | 273, 436, 514, 568 | 4 |
| 12 | 65, 465, 517, 534 | 4 |
| 13 | 39, 99, 227, 278, 394 | 5 |
| 14 | 113, 297, 317, 370, 386, 470 | 6 |
| 15 | 148, 181, 305, 336, 348, 434, 473 | 7 |
| 16 | 44, 152, 210, 249, 329, 501, 532, 549, 567 | 9 |
| 17 | 76, 81, 216, 397, 416, 489, 536 | 7 |

This reordered representation is described by the following equation:

$$t = {\sum }_{i = 0}^{m} {3}^{i} ( {\sum }_{j = 1}^{c ( i )} {2}^{{b}_{{1}^{( j )}}} )$$

In the above formula we make use of the following notation: m is the maximal ternary exponent used; c(i) is the number of binary exponents that correspond to the I-th ternary exponent,
0≦i≦m;

b₁^{(j)} is the j-th binary exponent which corresponds to the i-th ternary exponent,
1≦j≦c(i)
Note that in some cases c(i) might be zero.

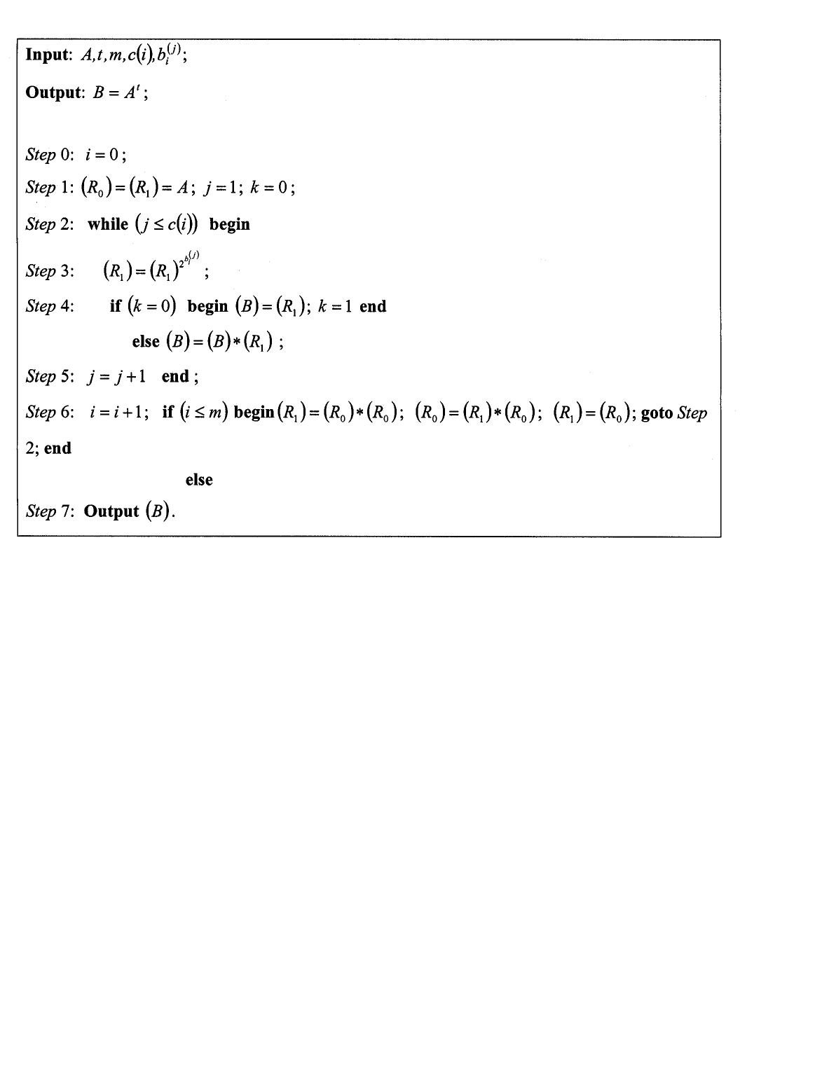

Using these notations, the algorithm shown in FIG. 1 is one example of an exponentiation with a demonstrably low number of regular multiplications.

In order to clarify the details, some comments on the above algorithm are provided. Step 1 sets the two registers (R₀) and (R₁). For example, if the computations are performed over GF(2″), then they are two variables of type GF(2″). Step 3 performs a cyclic shift of the current value of the register (R₁). Step 4 updates the value of (B), the register that will contain at the end of the algorithm the final result. We save one multiplication by observing that the first multiplication to update (B) can be replaced by an assignment of the multiplier to (B), since (B) is equal to one at this point. Step 6 explicitly cubes the value of register (R₀), that is, (R₀)=A³′, 0≦l≦m, and assigns it to (R₁). The final result is contained in (B).

Step 4 requires

$${\sum }_{i = 0}^{m} c ( i ) - 1 = d - 1$$

regular multiplications. Step 6 requires m regular multiplications. By applying the above algorithm to the 593-bit number used in Example 1, one gets 112 regular multiplications (96 in Step 4, and 16 in Step 6). By way of comparison, Stinson's algorithm, generally regarded by those skilled in the art as a fast one, results in 129 regular multiplications.

This algorithm is particularly suitable if the computational operations are performed over a large finite field with even characteristic. The use of normal bases representation of the elements of the field allows us to implement the squarings (see Step 3 and Step 6 of the example algorithm) as cyclic shifts, which can be implemented with a low VLSI cost function. ECC encryption technology, such as that described in U.S. Pat. No. 6,141,420, uses these algorithmic considerations to achieve significant computational speed up of the ECC encryption/decryption procedures.

### Example 3

Exponential Diophantine equations based complexity analysis

The purpose of the analysis in this Example is to demonstrate why the use of small ternary exponents leads to so drastic a reduction of the number of regular multiplications.

The average complexity of the methods described herein depends on the way the number of terms of the form 2^{a}3^{b} in equation (4) decreases (in the average case) as a function of the largest ternary exponent allowed. As exemplified before, consider that the exponent, t, is a 593-bit integer. In that case, the maximal exponent of three that can appear in a double-base number representation of t is 373. This choice corresponds to an unrestricted size of the ternary exponent and it is clearly unsuitable for the present invention. The minimal exponent of three is of course, zero, which corresponds to a purely binary representation. In this case the average number of ones is 297 and the expected number of regular multiplications is 296. In the case of an unrestricted ternary exponent, Theorem 1 indicates that the expected number of terms of the form 2^{a}3^{b} in formula (4) is

$$[ \frac{593}{{log}_{2} 593} ] = 64$$

Therefore, the upper bound of the maximal number of regular multiplications is 436. Clearly, neither binary nor purely double-base technique can outperform the prior art, which uses only an average of 129 regular multiplications. However, the inventors have demonstrated that by allowing only very small ternary exponents, one could sharply decrease the number of terms of the form 2^{a}3^{b} in (4). It is instructive to consider why this is the case, which may be understood with information from the theory of exponential Diophantine equations.

First of all, let us consider some very small values of m, that is, the largest ternary exponent allowed to be used.
1. m=0
This is the purely binary representation of the exponent, t. In this case half of the nonzero digits (bits) are expected to be ones. Therefore, the average number of regular multiplications is

$$[ \frac{{log}_{2} t}{2} ]$$
2. m=1

The first nontrivial case to be analysed is the largest ternary exponent allowed is one. If one applies the greedy algorithm, then the combination of numbers 2^{k} and 2^{k+1} cannot occur because they will be replaced by 3.2^{k}. With no restriction on the ternary exponent, every solution of the Diophantine equation:
X+y=z, GCD(x,y,z)=1, x,y,zε{2^{a}3^{b}a,b—nonnegative int egers} (6)
would produce an impossible combination of numbers (x,y). Equation (6) has exactly three solutions [16]: (1, 2, 3), (1, 3, 4) and (1, 8, 9). If the ternary exponent is restricted to be no larger than one, then only the first solution plays a role. For this particular case, that is, the largest ternary exponent one, the following theorem may be proved.

### Theorem 4

Let t be a positive integer that is represented via the greedy algorithm in the following form:

$$t = {\sum }_{i - 1}^{d} {3}^{{a}^{( i )}} {2}^{{b}^{( i ( )}} , \\ {a}^{( i )} ɛ \{ 0 , 1 \} , {b}^{( i )} \text{-} nonnegative integers \qquad ( 7 )$$

then the average value of d, the number of summands in (7), is

$$[ \frac{{log}_{2} t}{3} ]$$

Proof:

A single isolated bit ‘11’ occurs in the binary representation of t with probability ⅛ (corresponds to a succession of bits ‘010’).

Exactly two isolated consecutive bits ‘11’ occur in the binary representation of t with probability 1/16 (corresponds to a succession of bits ‘0110’). The greedy algorithm will reduce the two ones with one number of the form 3.2^{k}. If we have three consecutive one bits in the binary representation of t, then the greedy algorithm will replace the two most significant ones with one number of the form 3.2^{k}. Generally, if we have l consecutive ones in the binary representation of t, then the greedy algorithm will reduce them to ½ terms of the form 3.2^{k}, if l is even. If l is odd, then the greedy algorithm will reduce the number of nonzero binary digits to

$$\frac{l - 1}{2}$$

terms of the form 3.2^{k} and one power of two will remain unchanged. Thus, if t is represented in the form (7), then the average value of d, the number of summands of the form 3^{a(1)}2^{b(1)}a⁽¹⁾ε{0,1}, bⁱ⁾ nonnegative integers, is given by the following sum:

$$d = [ ( \frac{1}{8} + \frac{1}{16} + \frac{2}{32} + \frac{2}{64} + \frac{3}{128} + \frac{3}{256} + … ) {log}_{2} t ] \\ = [ ( {\sum }_{k = 2}^{∞} \frac{3 ( k - 1 )}{{2}^{2 k}} ) {lot}_{2} t ] \\ = [ \frac{{log}_{2} t}{3} ]$$

which completes the proof.

The above analysis shows that significant savings in terms of nonzero digits in DBNS can be achieved even if the largest ternary exponent allowed is only one. More to the point, one gets exactly the same reduction (33%) of the nonzero digits that is achieved in the binary signed-digit (SD) number representation but with a 33% reduction in the size of the digit set (the DBNS digit set is {0,1} vs {−1,0,1} for the SD number representation). From computational experiments with random numbers, the estimate obtained in Theorem 4 is in very good agreement with the numerical results.

By increasing the size of the ternary exponent allowed, much larger class of exponential Diophantine equations and their solutions start to play a role. For instance, if the ternary exponent is bounded by 2, then the solution (1,8,9) provides another impossible combination of numbers (x,y). Generally speaking, every solution of the exponential Diophantine equation:
x₁+x₂+ . . . +xₖ₋₁=x_{k′}GCD(xᵢ)=1, I=1,2, . . . , k (8)
in numbers of the form 2^{ai},3^{bi},I=1,2, . . . , k, aᵢ,bᵢ—nonnegative integers, generates some sort of reduction rule, which starts to play a role in reducing the number of nonzero digits as long as the largest ternary exponent allowed is greater than or equal to the largest bᵢ, l=1,2, . . . , k. The solutions [16,22] of the equation
x₁+x₂+x₃=x₄, x₁,x₂,x₃,x₄ε{2^{a}3^{b}}, GCD(x₁,x₂, x₃,x₄)=1 (9)

are shown in Table 4.

TABLE 4
The solutions of the Diophantine equation (9)

| | | | | | | | | |
|---|---|---|---|---|---|---|---|---|
| 1, 2, 3, 6 | 1, 2, 6, 9 | 1, 2, 9, 12 | 1, 2, 24, 27 | 1, 3, 4, 8 | 1, 3, 8, 12 | 1, 3, 12, 16 | 1, 3, 32, 36 | 1, 4, 27, 32 |
| 1, 6, 9, 16 | 1, 8, 9, 18 | 1, 8, 18, 27 | 1, 8, 27, 36 | 1, 8, 72, 81 | 1, 9, 54, 64 | 1, 12, 243, 256 | 1, 16, 64, 81 | 1, 27, 36, 64 |
| 1, 32, 48, 81 | 1, 256, 512, 729 | 2, 3, 4, 9 | 2, 3, 27, 32 | 2, 9, 16, 27 | 3, 4, 9, 16 | 3, 8, 16, 27 | 8, 9, 64, 81 | |

Another equation that plays a role in analysing the complexity of the greedy algorithm with reduced ternary exponent is:
X₁+x₂+x₃=x₄+x₅, x₁,x₂,x₃,x₄,x₅ε{2^{a}3^{b}}, GCD(x₁,x₂,x₃,x₄,x₅)=1 (10)
Computational experiments suggest that this equation possesses about 500 different solutions. However, in this particular case some solutions can be excluded since they do not lead to reduction of three numbers of the form 2^{a}3^{b} to two if one uses the greedy algorithm. The smallest example showing this state of affairs is 41; in this case the greedy algorithm returns 41=36+4+1, whereas 41=32+9 is the minimal representation of 41. The identity 36+4+1=32+9 shows a solution, such that max(x₁,x₂,x₃)>max(x₄,x₅). The solutions having this property do not produce needed reductions. However, only about ten percent of the solutions found by computational experiments possess this property.

The most general class of exponential Diophantine equations that can be considered in this case consists of the following equations:

$$\begin{matrix}{\sum }_{i = 1}^{k} {x}_{1} = {\sum }_{j = 1}^{1} {y}_{j ,} {x}_{1 ,} {y}_{j} ∈ \{ {2}^{a} {3}^{b} \} , \\ GCD ( {x}_{1} {x}_{2} , … , {x}_{k} , {y}_{1} , {y}_{2} , … , {y}_{1} ) = 1 , k ⊳ 1\end{matrix} \qquad ( 11 )$$

One of the most profound results in modern transcendental number theory asserts that the number of solutions of (11) is finite. The proven upper bound of the number of solutions is a double exponential function of the number of variables, k+1; the proven lower bound is a single exponential function of k+1 [18]. This is one of the reasons why 1) it is very difficult to find all the solutions and 2) it is probably impossible to thoroughly analyse their influence on the performance of the greedy algorithm.

As will be apparent to those skilled in the art, various modifications, adaptations and variations of the foregoing specific disclosure can be made without departing from the scope of the invention claimed herein. The various features and elements of the described invention may be combined in a manner different from the combinations described or claimed herein, without departing from the scope of the invention.

1. In a public key cryptographic method based on GF(2ⁿ)or GF(p) arithmetic, a method of exponentiation comprising the step of representing the exponent as a double base number of the form:
$$t = {\sum }_{i = 0}^{m} {F}_{k}^{i} ( {\sum }_{j = 1}^{c ( i )} {2}^{{b}_{{1}^{( j )}}} )$$
wherein Fₖ=2^{k}+1; m is the maximal Fₖ exponent used; c(i) is the number of binary exponents that correspond to the i-th Fₖ exponent, 0≦l≦m; and bᵢ^{j} is the j-th binary exponent which corresponds to the i-th Fₖ exponent, 1≦j≦c(i).

2. The method of claim 1 wherein Fₖ=3.

3. The method of claim 1 or 2 wherein m≦17.

4. The method of claim 3 wherein m≦8.

5. The method of claim 4 wherein m≦6.
